(19) United States
(12) Patent Application Publication
(10) Pub. No.: US 2010/0318372 A1
(43) Pub. Date: Dec. 16, 2010

(54) APPARATUS AND METHOD FOR DYNAMICALLY OPTIMIZED ELIGIBILITY DETERMINATION, DATA ACQUISITION, AND APPLICATION COMPLETION

(76) Inventors: Michael S. Band, Boca Raton, FL (US); Alan R Flaumenhaft, Orange, CT (US); Cory B. Fabiano, Miramar, FL (US)

Correspondence Address: Wright Law Group, PLLC;ATTN: Mark F. Wright, Suite 2, 7201 West Oakland, Chandler, AZ, 85226, US

(21) Appl. No.: 12/483,478

(22) Filed: Jun. 12, 2009

(51) Int. Cl. G06Q 10/00; G06F 17/30; G06N 5/02; G06F 17/00; G06Q 50/00; G06F 3/048

(52) U.S. Cl. 705/1.1; 706/52; 715/226; 715/825; 707/759; 707/713; 707/812

(57) ABSTRACT

The apparatus and methods disclosed herein provide a convenient and efficient computer-based process methodology for identifying and qualifying people for different solutions and outcomes and enrolling and/or registering people in appropriate programs as they are identified. The most preferred embodiments of the present invention comprise one or more structured computerized databases comprising: a set of outcomes, each with a corresponding set of appropriately-expressed eligibility requirements; a set of applications or forms and their corresponding necessary and unique named data elements, or variables, which may or may not relate to the aforementioned set of outcomes; a set of questions corresponding to the set of variables, each question relating to one or more variables; a set of question scripts corresponding to the set of questions, with one script per question; a set of question help prompt scripts corresponding to the set of questions, with one help prompt per question; a set of interview constructs that semantically relate sets of questions; and a subject definition comprised of named locations used to store variables and their corresponding values. Given the database and elements described above, the most preferred embodiments of the present invention comprise a system that performs: eligibility determination; data acquisition; and forms or application completion using collected data elements.

### BACKGROUND OF THE INVENTION

1. Field of the Invention

The present invention relates generally to computer systems used in conjunction with providing services, and more particularly, related to the use of computer systems used for determining eligibility for participation in one or more activities or programs.

2. Background Art

Various kinds of systems are available for evaluating and verifying the eligibility of a prospective participant in many assistance programs. This includes generic programs such as mortgage assistance and lending programs, as well as specific programs targeted at certain demographic groups that may be offered by governments and religious organizations, etc. (e.g., food stamps, job placement, reduced housing, medical insurance programs, child care programs, etc.). These various systems are generally computerized systems or computer-assisted interviewing methodologies that accept a number of criteria from the candidate, and assist the user in filling out an application. The application may be, for example, filled out electronically by an applicant or filled out by hand by the applicant, and subsequently input to a computer system using scanning or some type of manual data transcription method.

While the various systems employed today for gathering information about prospective participants for determining program eligibility are generally useful, there are many limitations that hinder the overall success of the information gathering process. For example, it may be necessary to have the prospective participant visit multiple agencies and fill out multiple forms, all without any type of coordination between the various forms or agencies. Additionally, a prospective participant is often required to fill out multiple lengthy forms without knowing whether or not he or she even meets the minimum eligibility requirements. After completing the lengthy form(s) in its/their entirety, it is possible that the prospective participant will learn that they don't even meet the minimum standards to be considered for assistance. This all-too frequent waste of time is not only inefficient and ineffective but can be discouraging to the applicant as well.

Accordingly, without additional improvements in the process methodology for determining the eligibility for prospective participants in various programs, particularly with respect to a single applicant and multiple programs, the time and energy expended in the application eligibility and enrollment process may continue to be less efficient than desired and the overall results will continue to be sub-optimal.

### SUMMARY OF THE INVENTION

The apparatus and methods disclosed herein provide a convenient and efficient computer-based process methodology for identifying and qualifying people for different solutions and outcomes (e.g., computer troubleshooting or scholarship-finding); and enrolling and/or registering people in appropriate programs (e.g., Medicare or mortgage programs) as they are identified. The most preferred embodiments of the present invention comprise one or more structured databases comprising:
A set of outcomes, each with a corresponding set of appropriately-expressed eligibility requirements;
A set of applications or forms and their corresponding necessary and unique named data elements, or variables, which may or may not relate to the aforementioned set of outcomes;
A set of questions corresponding to the set of variables, each question relating to one or more variables;
A set of question scripts corresponding to the set of questions, with one script per question;
A set of question help prompt scripts corresponding to the set of questions, with one help prompt per question;
A set of interview constructs that semantically relate sets of questions; and
A subject definition comprised of named locations used to store variables and their corresponding values.

Given the database and elements described above, the most preferred embodiments of the present invention comprise a system that performs the following three primary functions: Eligibility Determination—dynamic determination process resulting in zero or more outcomes or eligibilities; Acquisition—dynamic determination and acquisition of requisite data targeted towards one or more specific application submissions, and; Forms or Application Completion—the rapid and, to the extent possible, automated completion of application forms using collected data elements.

### BRIEF DESCRIPTION OF THE DRAWINGS

The preferred embodiments of the present invention will hereinafter be described in conjunction with the appended wherein like designations denote like elements and:

FIG. 1 is a block diagram of a computer system and related components for implementing a computer-based eligibility determination, enrollment, and management system in accordance with a preferred exemplary embodiment of the present invention;

FIG. 2 is a block diagram of a server used for implementing a computer-based eligibility determination, enrollment, and management system in accordance with a preferred exemplary embodiment of the present invention;

FIG. 3 is a flow chart for a methodology used in implementing a computer-based eligibility determination, enrollment, and management system in accordance with a preferred embodiment of the present invention;

FIG. 4 is a schematic diagram of the process of refining potential outcomes using a computer-based eligibility determination, enrollment, and management system in accordance with a preferred exemplary embodiment of the present invention;

FIG. 5 is flow chart for a method for refining potential outcomes using a computer-based eligibility determination, enrollment, and management system in accordance with a preferred exemplary embodiment of the present invention;

FIG. 6 is a schematic diagram of a dynamically optimized eligibility determination, enrollment, and management system in accordance with a preferred embodiment of the present invention;

FIG. 7 is a schematic diagram illustrating the communicative interactions of a dynamically optimized eligibility determination, enrollment, and management system in accordance with a preferred embodiment of the present invention;

FIG. 8 is a tabular presentation of an initial set of potential outcomes used in conjunction with a dynamically optimized eligibility determination, enrollment, and management system in accordance with a preferred embodiment of the present invention;

FIG. 9 is a tabular presentation of an initial set of variables used in conjunction with a dynamically optimized eligibility determination, enrollment, and management system in accordance with a preferred embodiment of the present invention;

FIG. 10 is a tabular presentation of a refined set of potential outcomes used in conjunction with a dynamically optimized eligibility determination, enrollment, and management system in accordance with a preferred embodiment of the present invention;

FIG. 11 is a tabular presentation of a refined set of potential variables used in conjunction with a dynamically optimized eligibility determination, enrollment, and management system in accordance with a preferred embodiment of the present invention;

FIG. 12 is a tabular presentation of a refined set of potential outcomes used in conjunction with a dynamically optimized eligibility determination, enrollment, and management system in accordance with a preferred embodiment of the present invention;

FIG. 13 is a tabular presentation of a refined set of potential variables used in conjunction with a dynamically optimized eligibility determination, enrollment, and management system in accordance with a preferred embodiment of the present invention;

FIG. 14 is a tabular presentation of a refined set of potential outcomes used in conjunction with a dynamically optimized eligibility determination, enrollment, and management system in accordance with a preferred embodiment of the present invention; and

FIG. 15 is a tabular presentation of a refined set of potential variables used in conjunction with a dynamically optimized eligibility determination, enrollment, and management system in accordance with a preferred embodiment of the present invention.

### DETAILED DESCRIPTION

The most preferred embodiments of the present invention are particularly well-suited for application in conjunction with business, government, and nonprofit organizations to help them improve upon existing processes that are used to screen applicants, determine eligibility, and to enroll and/or register the applicants in the appropriate programs using various forms or applications. The most preferred embodiments of the present invention comprises three distinct components that are capable of operating independently but are most effective when combined together. The three components are:
Eligibility determination, screening, or qualification—The most preferred embodiments of the present invention are most applicable in a business or other entities that have need of a way to determine client eligibility. It would be especially helpful where eligibility determinations are already made via personal inquiries and assessments conducted during an interview process. Given a specific formulary, or set of formulas, each describing in algebraic terms what is required to be eligible for a specific outcome; the most preferred embodiments of the present invention provides a series of mechanisms that will dynamically generate and continually optimize a human to human or human to computer interview until every possible eligibility path has been exhausted and a final determination or a set of final outcomes has been obtained. As an example, assume a mortgage brokering business had developed an algebraic formulary describing the requirements for each of their available mortgage programs. One preferred embodiment of the present invention would be configured able to dynamically build interview scenarios and questions that would prompt an interviewer to ask every relevant question that might assist in making a determination of eligibility for all of their available mortgage programs. The final outcome would be an identified set of mortgage programs for which the applicant qualifies. In addition, certain preferred embodiments of the present invention could be used to statically test program eligibility where previously gathered information about a subject is measured for eligibility against a set of outcomes.

Using the mortgage broker example, there would be no interview. Instead, all that is known about the applicant would be made known to a specific preferred embodiment of the present invention and the output would be an eligibility determination for every available mortgage program in the formulary.
Data acquisition or enrollment—The most preferred embodiments of the present invention are be applicable to a business or other entity that seeks to collect the data to enroll persons in a plurality of programs or to collect data necessary to register items. In a case where an interviewer is going to interview a candidate in order to collect information about a given program or subject, the preferred embodiments of the present invention can make those interviews more efficient. Using the previous mortgage broker example; if the interviewer were going to help someone apply for several different mortgage programs (presumably those mortgage programs for which they had already been qualified using the aforementioned eligibility determination mechanisms) the preferred embodiments of the present invention would be configured to generate and dynamically adjust a data acquisition interview to collect all of those data elements that would be necessary for an applicant to apply for the previously identified set of desired mortgage programs. The most preferred embodiments of the present invention would be configured to optimize the interview by eliminating redundant questions, filtering out questions that are determined to be inapplicable, and not repeating any questions to collect previously known information.

Forms or application rendering—The most preferred embodiments of the present invention are also applicable in an environment where forms for enrollment or item registration are required. Given a set of forms required for enrollment or registration that have had their fields mapped, or related to, a set of collected data elements (especially where the data elements have been acquired in the aforementioned qualification or data acquisition processes) the most preferred embodiments of the present invention can be configured to create and print forms that have been rendered (filled-out) with a given subject's relevant information. Using the mortgage broker example to help illustrate once again, after a mortgage applicant has been through qualification and enrollment interviews (as previously described), all of the necessary data to complete the forms necessary to enroll the applicant in the desired mortgage programs are stored in a database. The most preferred embodiments of the present invention would take that applicant's information and render (fill-out) all requisite forms in an easy-to-print format (e.g. portable document format (PDF) or word-processor compatible file format) in order to allow the mortgage broker to submit the completed forms to the various banks or mortgage companies for processing and approval.

In summary, the most preferred embodiments of the present invention can be used to streamline the processes of businesses or other entities involved in: qualifying people for different solutions and outcomes (like computer troubleshooting or scholarship-finding); and enrolling and/or registering people in different programs (like Medicare or mortgage programs). It also helps facilitate the completion of these processes by making any changes in forms or eligibility a fast and easy process. If required, changes in programs, program eligibility, and forms would not have to be made in any software or source code; rather the changes can be made in form definitions, questions, and eligibility formularies. This allows for rapid deployment of new programs, processes, and eligibility determination criteria.

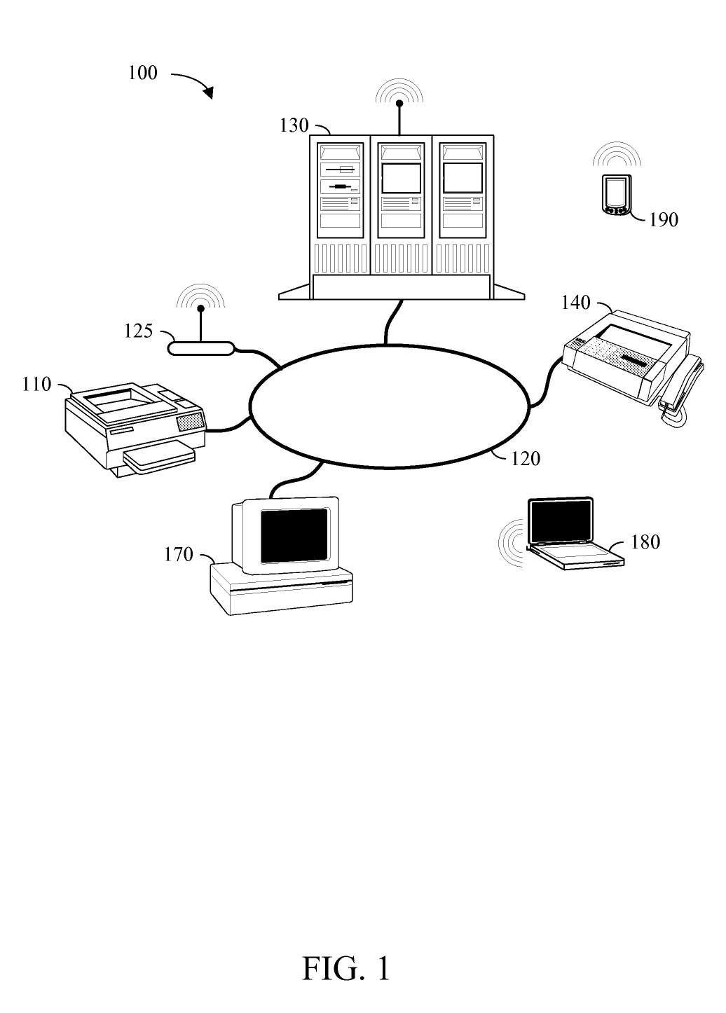

Referring now to FIG. 1, a computer-based eligibility determination, enrollment, and management system 100 in accordance with a preferred embodiment of the present invention comprises: at least one wireless communication device 125; a data server 130; a desktop computer 170; a laptop computer 180, and a personal digital assistant 190; all connected or coupled via a network 120. Additionally, an optional printer 110, and an optional fax machine 140 are shown.

Taken together, the components of computer-based benefits eligibility determination, enrollment, and management system 100 provide a way for a disparate user base, including program administrators, managers, and clients, to access one or more components or subsystems of computer-based eligibility determination, enrollment, and management system 100 as described herein in conjunction with the various preferred embodiments of the present invention. While the present invention will be described in detail by using various examples of a typical application process for a mortgage or medical benefits program, those skilled in the art will recognize that the methods and techniques described herein have broad applicability to other environments and applications where quick and efficient eligibility determination, enrollment, and rendering is desirable.

Network 120 is any suitable computer communication link or communication mechanism, including a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention, at least a portion of network 120 comprises a standard Internet connection between the various components of computer-based benefits eligibility determination, enrollment, and management system 100. Network 120 provides for communication between the various components of computer-based benefits eligibility determination, enrollment, and management system 100 and allows for relevant information to be transmitted from device to device. In this fashion, a user of computer-based benefits eligibility, enrollment, and management system 100 can quickly and easily gain access to the relevant data and information utilized to search, retrieve, and display information from one or more databases as described in conjunction with the preferred embodiments of the present invention.

Wireless communication device 125 is communicatively coupled to network 120 and is representative of any wireless communication mechanism that may be used to provide for wireless communication between network 120 and the various devices associated with network 120, including desktop computer 170, laptop computer 180 and PDA 190. Wireless communication device 125 may comprise any type of wireless bridge, wireless router, or similar type of device.

Regardless of the specific components, physical nature, and topology, network 120 serves to logically and communicatively link the physical components of computer-based eligibility determination, enrollment, and management system 100 together, regardless of their physical proximity, thereby enabling communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or PDA 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with eligibility determination, enrollment, and management system 100 as described herein. This includes various levels of desktop computers, tablet computers, pen-based computers and the like. Additionally, handheld and palmtop devices are also specifically included within the description of devices that may be deployed as a computer system 170. It should be noted that no specific operating system or hardware platform is excluded and it is anticipated that many different hardware and software platforms may be configured to create computer system 170. As previously explained in conjunction with data server 130, various hardware components and software components (not shown this FIG.) known to those skilled in the art may be used in conjunction with computer system 170. It should be noted that in the most preferred embodiments of the present invention, desktop computer 170 is linked (via wired or wireless connection) to its own LAN or WAN and has access to its own data server (not shown this FIG.).

Similarly, laptop computer 180 may be any type of relatively lightweight portable computer system known to those skilled in the art that is capable of being configured for use with eligibility determination, enrollment, and management system 100 as described herein. This includes tablet computers, pen-based computers and the like. Additionally, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be requests for entering date into or retrieving data from one or more databases located on data server 130. The users of desktop computer 170 and/or laptop computer 180 may be program administrators, managers and/or prospective clients who are seeking to make determinations regarding program eligibility and related activities. Additionally, various related service providers such as government agencies, banks, insurance companies, mortgage companies, benefits administrators, and their employers and agents may also have access to one or more databases located on data server 130 via desktop computer 170 and/or laptop computer 180. A typical transaction may be represented by a request for a benefits eligibility determination for a prospective client. In this case, a request to access the prospective client's data file is sent from desktop computer 170 and/or laptop computer 180 to data server 130.

Upon receipt of a valid request, data server 130 processes the request to access one or more databases containing the relevant information and takes the specific action requested by desktop computer 170 and/or laptop computer 180, typically by retrieving and returning the requested data to desktop computer 170 and/or laptop computer 180. The request may be directed towards locating a specific item in a database, comparing one or more items in the database, obtaining additional information from a database about one or more prospective clients, determining and calculating benefits eligibility, or other similar requests.

It should be noted that while FIG. 1 shows only a single desktop computer 170 and a single laptop computer 180, it is anticipated that the most preferred embodiments of the present invention will comprise hundreds and even thousands of computer systems 170 and laptop computers 180. Each of these computers 170 and 180 will be configured to access data server 130 in an appropriately secure way so as to accomplish the specific objectives of the user of the desktop computer 170 or laptop computer 180. For example, the service provider that controls the databases stored on data server 130 may utilize desktop computer 170 or laptop computer 180 to access data server 130 and create or modify a given database. An insurance provider, located in a remote location, may use desktop computer 170 or laptop computer 180 to access data server 130 to retrieve information about benefits for one or more clients that are stored in a database stored on data server 130, etc.

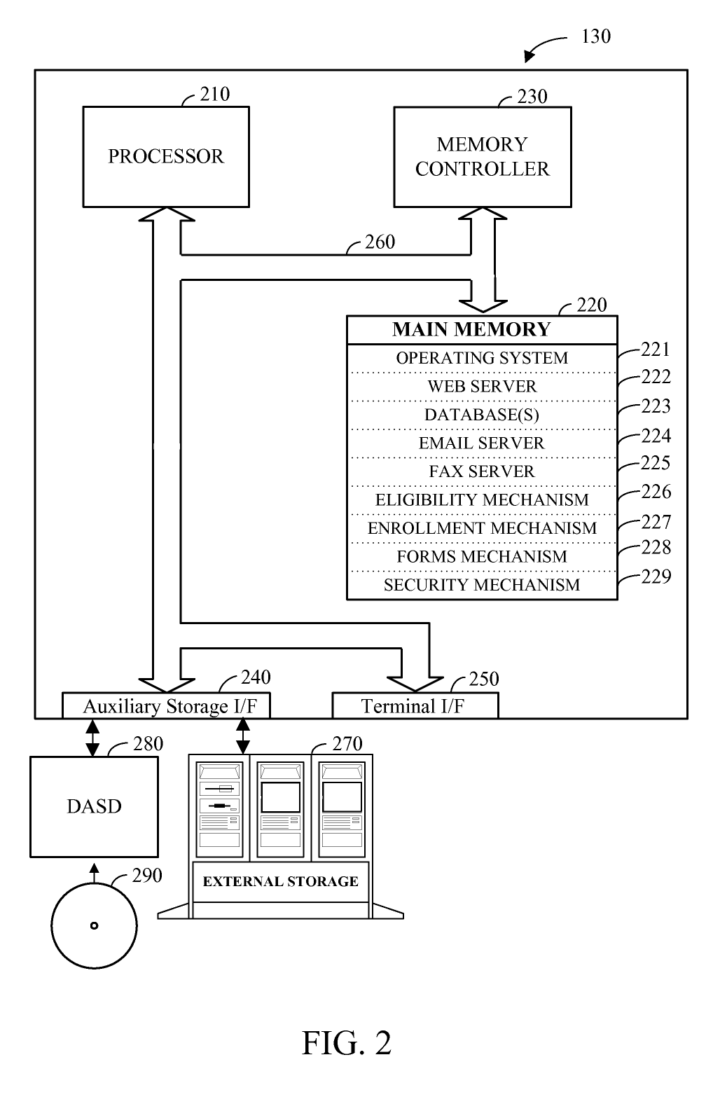

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) environment where data server 130 is operated as a clearinghouse in a hosted operation. In this fashion, multiple desktop computers 170 and laptop computers 180 will have access to data server 130 and the databases stored thereon via a global computer network such as the Internet. Data server 130 is further described below in conjunction with FIG. 2 below.

Optional printer 110 and an optional fax machine 140 are standard peripheral devices that may be used for transmitting or outputting paper-based documents, notes, transaction details, reports, etc. in conjunction with the various requests and transactions processed by eligibility determination, enrollment, and management system 100. Optional printer 110 and an optional fax machine 140 may be directly connected to network 120 or indirectly connected to network 120 via any or all of desktop computers 170, laptop computers 180, and/or data server 130. Finally, it should be noted that optional printer 110 and optional fax machine 140 are merely representative of the many types of peripherals that may be utilized in conjunction with eligibility determination, enrollment, and management system 100. It is anticipated that other similar peripheral devices will be deployed in the various preferred embodiment of the present invention and no such device is excluded by its omission in FIG. 1.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of eligibility determination, enrollment, and management system 100.

Personal digital assistant (PDA) 190 is representative of a class of devices that are at least somewhat less full-featured and less powerful than computers 170 and 180. This includes, for example, Windows mobile OS devices, Palm OS devices, Pocket PC devices, and various types of “smart phones” for example. Those skilled in the art will recognize these various devices and others that are suitable for deployment as PDA 190. While somewhat less powerful than computers 170 and 180, PDA 190 is also configured to communicate with data server 130 via network 120 to send and retrieve program eligibility related information to and from data server 130. Given the standard functionality for devices that may be deployed as PDA 190, this communication will typically be a wireless Internet connection (e.g. “wi-fi” or “wi-max”) or a Bluetooth connection. One example of the use for PDA 190 in the context of eligibility determination, enrollment, and management system 100 would be a data collection activity conducting off-site visits to prospective clients for one or more medical insurance benefits programs with the resulting information being collected and stored in a database on data server 130 for later access.

Referring now to FIG. 2, data server 130 of FIG. 1 in accordance with a preferred embodiment of the present invention represents one of many commercially available computer systems such as a Linux-based computer system, an IBM compatible computer system, or a Macintosh computer system. However, those skilled in the art will appreciate that the methods and apparatus of the present invention apply equally to any computer system, regardless of the specific operating system and regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 suitably executes one or more software programs contained within main memory 220.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

It is important to note that while the present invention has been (and will continue to be) described in the context of a fully functional computer system with certain application software, those skilled in the art will appreciate that the various software mechanisms of the present invention are capable of being distributed in conjunction with tangible signal bearing media as one or more program products in a variety of forms, and that the various preferred embodiments of the present invention applies equally regardless of the particular type or location of signal bearing media used to actually carry out the distribution. Examples of signal bearing media include: recordable type media such as DVD and CD ROMS disks (e.g., disk 290), and transmission type media such as digital and analog communication links, including wireless communication links.

Various preferred embodiments of the program product may be configured to: create and modify multiple databases; track, update and store benefits and program eligibility information for a plurality of clients and prospective clients, insurance agents and companies, benefits coordinators, government officials, healthcare providers, and healthcare facilities; configure and implement various search and retrieve functions for a multitude of program and benefits eligibility search requests and determinations made by users of the system; track and store information about various programs and benefits; update and transmit search results to one or more users; and provide one or more user interfaces for accomplishing all of these functions. In this fashion, the appropriate entities (i.e., administrators, clients, patients, insurance providers, managers, etc.) can utilize the program product to initiate and complete a wide variety of database-related applications. Similarly, a program product in accordance with one or more preferred embodiments of the present invention can also be configured to perform substantially all of the steps depicted and described in conjunction with the figures below for implementing an eligibility determination, enrollment, and management system.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, managers, system administrators, and/or computer programmers to communicate with data server 130, normally through separate workstations or through stand-alone computer systems such as computer systems 170 and computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, one or more databases 223, an email server 224, a fax server 225, an eligibility mechanism 226, an enrollment mechanism 227, a forms mechanism 228, and a security mechanism 229. An eligibility mechanism, data mechanism 227, and forms mechanism 228 rules also comprise a rules engine and workflow model to assist with the overall flow of data storage and retrieval. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual components shown in main memory 220 might be combined in various forms and distributed as a stand-alone program product. Finally, it should be noted that additional software components, not shown in this figure, might also be included.

For example, most preferred embodiments of the present invention will include a security and/or encryption mechanism 229 for verifying access to the data and information contained in and transmitted by data server 130. Security mechanism 229 may be incorporated into operating system 221 and/or web server 222. Additionally, security mechanism 229 may also provide encryption capabilities for other components of eligibility determination, enrollment, and management system 100 of FIG. 1, thereby enhancing the robustness of eligibility determination, enrollment, and management system 100. Security mechanism 229 is most preferably configured to protect the integrity and security of the information transmitted via network 120 of FIG. 1. Given the present levels of concern for the protection of personally identifiable information (PII) by laws such as the Health Insurance Portability and Accountability Act (HIPAA) and the Graham-Leach Bliley Act (GLBA), the function of security mechanism 229 is important for compliance issues and to ensure that all PII is adequately protected from inadvertent disclosure and unauthorized access.

Once again, depending on the type and quantity of information stored in database 223 and accessed by enrollment mechanism 227, security mechanism 229 may provide different levels of security and/or encryption for different computer systems 170 and 180 of FIG. 1. Additionally, the level and type of security measures applied by security mechanism 229 may be determined by the identity of the end-user and/or the nature of a given request and/or response. In some preferred embodiments of the present invention, security mechanism 229 may be contained in or implemented in conjunction with certain hardware components (not shown this FIG.) such as hardware-based firewalls, switches, dongles, and the like.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with web portal application 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of eligibility determination, enrollment, and management system 100 of FIG. 1. In the most preferred embodiments of the present invention, database 223 will comprise a collection of information about potential participants and their attributes and specific situation/circumstances as well as providing for the tracking and management of multiple programs, programs requirements, procedures and protocols that may be used to provide various services to the prospective program participants.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

While not required, the most preferred embodiments of data server 130 of FIG. 1 will typically include an email server 224. E-mail server 224 is any email server application capable of being configured and used to send and receive various status messages and updates to data server 130 and between computers 170, 180, and/or 190 of FIG. 1 via email, as may be necessary to enhance the overall process of completing various indexing, search-and-retrieve and/or eligibility determination transactions described herein. This includes the generation of automated email messages relating to the tracking and management of various programs as well as informational messages related to prospective clients and the status of eligibility determination, enrollment, and management system 100 of FIG. 1. Automated e-mail messages are also generated to provide notifications regarding the status of user accounts as well as other information for related to the programs and prospective participants in accordance with the preferred embodiments of the present invention.

Optional fax server 225 is any fax server known to those skilled in the art and is configured to receive inbound fax messages and to transmit outbound fax messages. Fax server 225 may format and transmit any data processed by eligibility determination, enrollment, and management system 100 of FIG. 1 and make it available for use by any other component of eligibility determination, enrollment, and management system 100 of FIG. 1. Additionally, fax server 225 may process the data received and send it directly to web server 222 and make the incoming data available for further processing by eligibility determination, enrollment, and management system 100, including eligibility mechanism 226, enrollment mechanism 227, and forms mechanism 228.

Eligibility mechanism 226 is a software mechanism that helps in determining the potential eligibility of a candidate for participation in one or more programs. The most preferred embodiments of the present invention preferably comprises one or more user customizable web-based templates that can be utilized to create one or more user interfaces for accessing eligibility mechanism 226. In this fashion, eligibility mechanism 226 may be readily adapted for multiple programs and multiple candidates.

Enrollment mechanism 227 is a software mechanism that helps to quickly and most efficiently gather the data points necessary for a candidate to participate in one or more programs. The most preferred embodiments of the present invention preferably comprises one or more user customizable web-based templates that can be utilized to create one or more user interfaces for accessing enrollment mechanism 227. In this fashion, enrollment mechanism 227 may be readily adapted for multiple programs and multiple candidates.

Forms mechanism 228 is a software mechanism that helps in formatting and creating the various forms necessary to complete the enrollment process for entering a candidate into one or more programs. The most preferred embodiments of the present invention preferably comprises one or more user customizable web-based templates that can be utilized to create one or more user interfaces for accessing form mechanism 228. In this fashion, forms mechanism 228 may be readily adapted for multiple programs and multiple candidates. In addition, forms rendering mechanism 228 is configured for deployment in a “rendering process” that takes the information gathered from the Subject during the enrollment step and embeds it onto a form or some other type of electronic destination source.

Additionally, in the most preferred embodiments of the presenting invention, forms mechanism 228 may be configured to perform a form filtering function. The form filtering mechanism is configured to review the actual programs that a given candidate is eligible for, after completion of the data-gathering process during the enrollment step. With the eligible programs being identified, the specific forms required for enrolling in the program can also be identified. The form filtering mechanism is also configured to identify the specific data elements necessary for rendering the forms required for enrollment of the candidate in the approved programs. Then, the form filtering mechanism may generate additional questions to be posed to the candidate to solicit any required information that has not already been collected during the dynamic interview process. As previously mentioned, the information solicitation process is conducted so as to ask each question only one time, and to use appropriate responses to populate and render the necessary forms as efficiently as possible.

Since there are many types of possible destinations and sources, there is no particular limitation on the output of forms mechanism 228. Those skilled in the art will recognize that word processing documents, PDF documents, database entries and other forms of data presentation and storage processes, whether electronic or paper-based, are all encompassed with the rendering process performed by forms mechanism 228. Since it is a relatively universal type of document for most operating systems, examples using a PDF document will be presented as one preferred embodiment for the output of the rendering process from forms mechanism 228.

In this fashion, the users of eligibility determination, enrollment, and management system 100 of FIG. 1 can more effectively identify, qualify, and enroll prospective candidates into one or more programs. The procedures set forth below will also allow eligibility determination, enrollment, and management system 100 of FIG. 1 to automatically generate email and or fax messages to be routed to the appropriate managers, user and operators of eligibility determination, enrollment, and management system 100 of FIG. 1, thereby increasing efficiency and reducing the time necessary to complete the overall enrollment of new candidates into various programs.

In the most preferred embodiments of the present invention, the various components of eligibility determination, enrollment, and management system 100 of FIG. 1 are able to communicate using multiple communications protocols, including “SOAP,” eXtended Markup Language (XML), and others. Those skilled in the art will recognize that the communication protocols used herein may be readily adapted and configured to allow for the rapid and efficient transmission and receipt of data by and between the various components of eligibility determination, enrollment, and management system 100 of FIG. 1. This would also include the ability to customize the input and output of eligibility determination, enrollment, and management system 100 of FIG. 1 for integration with other systems. The use of XML and similar electronic communication protocols in general is well known to those skilled in the art.

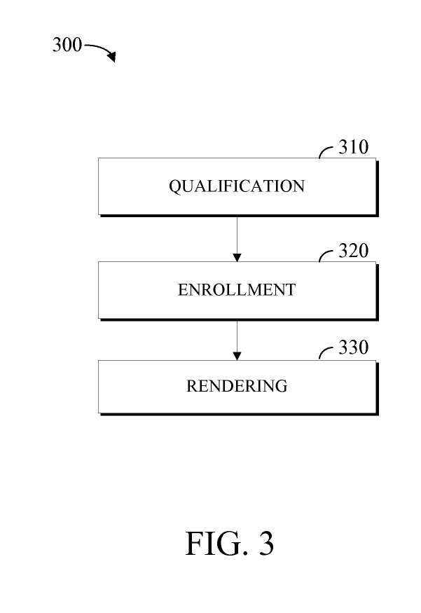

Referring now to FIG. 3, a flow chart for a methodology 300 used in implementing a computer-based eligibility determination, enrollment, and management system in accordance with a preferred embodiment of the present invention is depicted. As shown in FIG. 3, the most preferred embodiments of method 300 comprises three main steps—qualification (step 310), enrollment (step 320), and rendering (step 330). Each of these steps is described in greater detail below.

Qualification (step 310), at the most basic level, functions as the process of qualifying the most beneficial set of results or “Outcomes” for a prospective program participant or “Subject.” These Outcomes could be anything from eligibility determination for one or more government welfare programs to the results of a computer troubleshooting program. For purposes of providing a specific example, a scenario where a mortgage broker uses a computer-based eligibility determination, enrollment, and management system in accordance with a preferred embodiment of the present invention to help applicants more easily find the programs for which they are qualified will be presented.

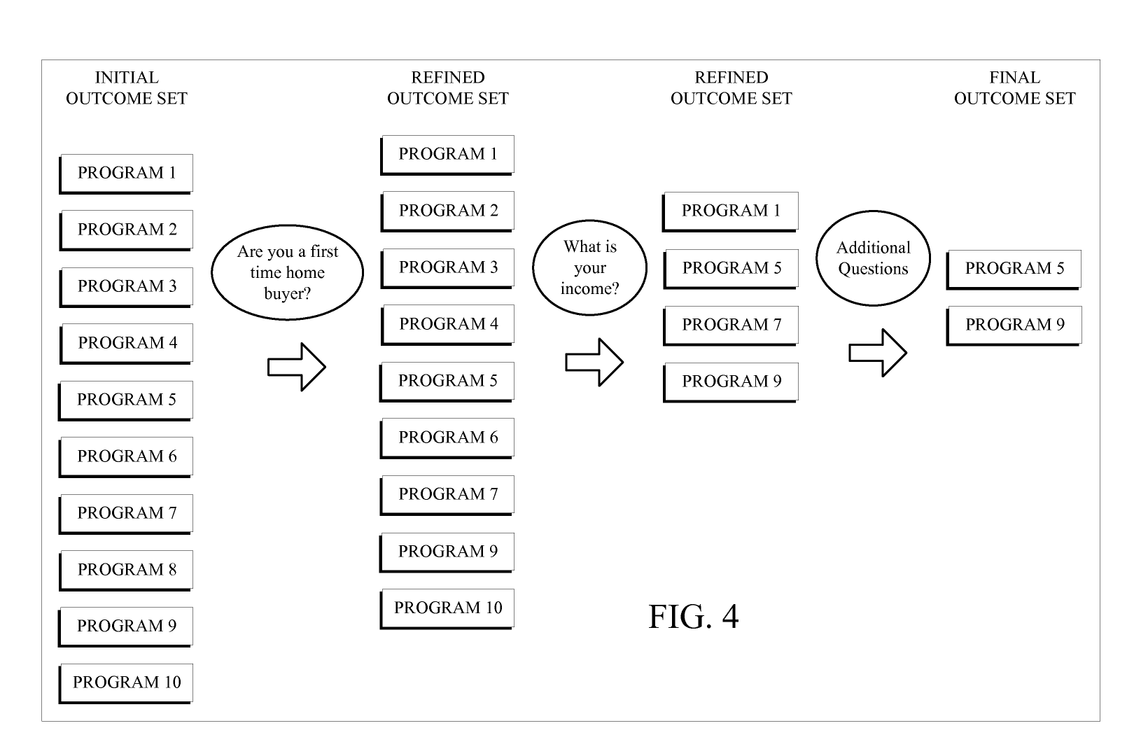

In this example, a mortgage broker may have ten different mortgage programs incorporated into computer-based eligibility determination, enrollment, and management system 100 of FIG. 1. These ten programs represent the full set of possible programs or outcomes for which a given mortgage applicant (Subject) could apply. This set of programs is called the “Initial Outcome Set” (see FIG. 4). Each program (Outcome) in this set has a specific set of criteria, or Outcome Attributes, associated with it and that must be met in order for the mortgage applicant to qualify for that specific program. In order to obtain the necessary information, the user of eligibility determination, enrollment, and management system 100 of FIG. 1 asks the mortgage applicant questions in an interview setting. If the user of eligibility determination, enrollment, and management system 100 of FIG. 1 was to pose the question; “Are you a first time home buyer?” and the mortgage applicant answered “Yes”, then the user of eligibility determination, enrollment, and management system 100 of FIG. 1 would continue to ask more questions based on the Outcome Attributes in the resultant Outcome Set (see FIG. 4).

The process of asking the qualification questions to reduce the possible Outcomes is called a “Qualification Interview.” The mortgage applicant, in this example, would need to complete a Qualification Interview that would pose questions regarding the eligibility for participation in each specific mortgage program. Every answer would refine the initial set of ten mortgage programs, meaning; for each question answered, each program could potentially be removed from the initial Outcome Set. When this occurs, the Initial Outcome Set is reduced to a Refined Outcome Set. In this case, as shown in FIG. 4, if the applicant responds “No” to the “first time home buyer” question then that mortgage program is removed from the Initial Outcome Set. This leaves nine programs in the Refined Outcome Set for which the applicant may potentially qualify. Depending upon the answers provided, eligibility determination, enrollment, and management system 100 of FIG. 1 will change the remaining questions in the Interview to so as to ask the most discriminating questions (e.g., those that lead to the most rapid and efficient solution set for a given applicant).

The user of eligibility determination, enrollment, and management system 100 of FIG. 1 will pose the minimum set of questions the mortgage applicant or candidate has to answer in order to arrive at the final set of Outcomes. In this example, eligibility determination, enrollment, and management system 100 of FIG. 1 is designed to construct a Dynamic Interview that changes with each question in order to create the most succinct and discriminating Interview. By discriminating, it is to say that both the questions and the order of questions to be asked is determined by each question's ability to refine the Outcome Set most effectively and efficiently.

For situations where an interactive Dynamic Interview is not necessary or desirable, eligibility determination, enrollment, and management system 100 of FIG. 1 can a configure an Interview that can be satisfied by either a Subject answering questions or by interacting with a software program (e.g. computer-based interview with a database program) that supplies eligibility determination, enrollment, and management system 100 of FIG. 1 with the necessary Subject information. This type of Interview is called a “Static Interview.” In a practical situation, a mortgage company could use electronically stored information already known about their current clients and feed the information to eligibility determination, enrollment, and management system 100 of FIG. 1.

In turn, eligibility determination, enrollment, and management system 100 of FIG. 1 will return all mortgages for which the Subject is qualified. This is termed a Static Interview because eligibility determination, enrollment, and management system 100 of FIG. 1 does not dynamically inquire for information in real time but uses existing information to qualify a client for one or more programs. Regardless of the actual process of the Interview, the eventual result is the Outcome or Outcomes best fitted to a given Subject.

After the final set of Outcomes has been determined, some or even all of the resultant Outcomes may have forms or applications that must be generated for the enrollment process to be completed. Whether the Outcomes are social programs, computer problems, or scholarships; the Qualification Interview process can be used to identify those Outcomes that a given Subject is qualified for. Depending on the Outcome, however, that may not be the final step. Some Outcomes, like social programs and scholarships, may have applications that need to be completed. Any required application associated with an Outcome is known as a “Form.”

These Forms would most often be application forms for programs like scholarships or mortgages; but could also be configured as data logs for someone registering items in a warehouse. Continuing with the previous example, assume that the mortgage broker has used eligibility determination, enrollment, and management system 100 of FIG. 1 to find the mortgage programs that the client is qualified for and has chosen the specific mortgage program deemed most appropriate for this specific client.

Typically, all Forms have one or more questions assigned to them, and each answer to each of these questions may be embedded into one or more fields associated with the questions. These fields are called “Form Fields.” For example, most forms will has several Form Fields such as name, social security number, and date of birth. Each of these fields has a question associated with them such as “What is your name?”, “What is your Social Security Number?,” and “What is your date of birth?.” These questions can be programmed into a specific Interview that will be invoked for the appropriate Form, thereby creating one or more Interviews for a given Form. During the interview, questions and responses can be visually displayed on a computer monitor, printed out on a printer, or even vocalized, using appropriate text-to-speech and speech-to-text conversion utilities.

Rather than compose Forms with questions exclusively tied to a single Form, eligibility determination, enrollment, and management system 100 of FIG. 1 will utilizes a single Interview that can be used by all Forms. Rather than force every Form to have an individual question that asks “What is your first name?” eligibility determination, enrollment, and management system 100 of FIG. 1 would instead have one question where all Forms could access and extract the appropriate answer from that question. By allowing eligibility determination, enrollment, and management system 100 of FIG. 1 to use the same questions in multiple Forms, eligibility determination, enrollment, and management system 100 of FIG. 1 also gains the ability to use the same values input by the Subject in multiple Forms.

For example, a candidate or Subject would only ever need to answer the question, “What is your ethnicity?” one time and then that answer to that question would be stored in the database and could be accessed by every Form required by every program into which the Subject is enrolling and for which the Subject ethnicity is a required element. Additionally, all questions used in any Interview (Qualification and Enrollment) are stored together and can be used by both Interviews. As such, all information acquired in a Qualification Interview can also be used to satisfy questions in the Enrollment Interview and, to the extent practical, to complete any required Forms as well. This allows for efficiency throughout the qualification and enrollment process.

At the most basic level, a Qualification Interview is a series of information gathering questions that are posed to the Subject. The order of sections and questions being asked is generally governed during configuration are should usually be decided and implemented before an interview is started.

When a Subject answers a given question in a Qualification Interview, eligibility determination, enrollment, and management system 100 of FIG. 1 collects that information and stores it in the database as a property of the Subject, called a Subject Property. If the question posed were “Are you a first time home buyer?” and the mortgage applicant answered “Yes, I am a first-time home buyer,” then that piece of information would be stored as a property of the Subject confirming that “Yes, this Subject is a first-time home buyer.” In this fashion, a Subject Property is a piece of information is associated with a Subject, with each Subject Property being stored in a Subject Data File. Each Subject Property gains value from the answer to a question in an Interview. By storing the Subject's information in a Subject Data File, eligibility determination, enrollment, and management system 100 of FIG. 1 can access it to retrieve any information about a Subject at any point in time.

Whether the Subject is enrolling using a single form or even ten Forms, eligibility determination, enrollment, and management system 100 of FIG. 1 constructs an Enrollment Interview made up of all the unique questions that the each of the Form(s) reference. This Interview contains all of the questions whose values have not already been gathered during the Qualification Interview. As each question is answered in the Enrollment Interview, eligibility determination, enrollment, and management system 100 of FIG. 1 updates the Subject Property in the Subject Data File piece by piece. As an example, if a Subject had previously indicated that his first name is “John,” then eligibility determination, enrollment, and management system 100 of FIG. 1 would store that Subject Property in his Subject Data File. If the Subject returned to the same question in the Interview and instead input his name as “James”, then eligibility determination, enrollment, and management system 100 of FIG. 1 would go to the Subject Data File and change only that property from “John” to “James” immediately. With this function, eligibility determination, enrollment, and management system 100 of FIG. 1 allows any software in which it is implemented to always have the most up-to-date copy of a Subject Data File. This ability would be valuable for anyone should the computer shuts down in the middle of a 40 page Enrollment Interview.

Eligibility determination, enrollment, and management system 100 of FIG. 1 will assist the user of eligibility determination, enrollment, and management system 100 of FIG. 1 in filling out the Forms for the required mortgage applications with the same process it used to find the mortgages in the first place; by constructing and conducting an interview. In order to complete the application, eligibility determination, enrollment, and management system 100 of FIG. 1 needs to gather certain information from the Subject (mortgage client) so it automatically constructs an interview filled with questions relevant to each necessary form. This interview is referred to as the “Enrollment Interview” as this is the point where eligibility determination, enrollment, and management system 100 of FIG. 1 collects form-specific information in preparation of enrolling the Subject in a selected program or programs.

For example, if the mortgage application requires the client's first name, eligibility determination, enrollment, and management system 100 of FIG. 1 will generate a question to the applicant such as, “What is your first name?” during the Enrollment Interview. It should be noted that, on occasion, the questions being asked during the Enrollment Interview overlap with the questions asked in the Qualification Interview. When this occurs, eligibility determination, enrollment, and management system 100 of FIG. 1 will not ask the same question twice. Instead, eligibility determination, enrollment, and management system 100 of FIG. 1 will simply use the information gathered in the Qualification Interview to provide the necessary answers needed in the Enrollment Interview. For example, if the Qualification Interview asked for the client's first name, then the Subject would not be asked the same question during the Enrollment Interview. The same question in the Enrollment Interview will be answered automatically.

The Enrollment Interview generated by eligibility determination, enrollment, and management system 100 of FIG. 1 is similar to the Qualification Interview on the surface. However, instead of answering questions to filter an Outcome Set, the answers to the questions posed during the Enrollment Interview are destined to populate an application or document. The Enrollment Interview essentially replaces the need to fill out any forms/applications that an Outcome may require by hand.

Eligibility determination, enrollment, and management system 100 of FIG. 1 assists in the Interview process by driving the Subject through the Enrollment Interview and forcing the completion of the Interview, question by question. In this fashion, eligibility determination, enrollment, and management system 100 of FIG. 1 eliminates the risk of skipping ahead to answer certain questions and leaving other questions blank. This process ensures a robust application procedure with all necessary data being gathered in a timely fashion.

During the Enrollment Interview, eligibility determination, enrollment, and management system 100 of FIG. 1 generally directs the flow of the Enrollment Interview by systematically requiring the Subject to answer each question in the order that they are given. Once completed, eligibility determination, enrollment, and management system 100 of FIG. 1 can be operated in the “Edit Mode,” which allows the user of eligibility determination, enrollment, and management system 100 of FIG. 1 or the Subject (for self-directed interviews) to return to each question in the Enrollment Interview and check and/or change answers. Anyone can skip questions and leave them completely blank without a care in the world. Edit Mode can be configured any number of ways. It may appear as a normal Interview, with questions kept in distinct sections, or it may be configured with an interface that displays the entire Interview on one or more screens at the same time or in sequence. Whatever the configuration, Edit Mode may be used to allow changes to be made quickly to a completed Enrollment Interview.

Eligibility determination, enrollment, and management system 100 of FIG. 1 can also assist in completing multiple applications (and the associated forms) by generating a single Interview containing all of the unique questions from multiple applications. As a simple example, eligibility determination, enrollment, and management system 100 of FIG. 1 would only require the client to supply a full name once. This information could then be used to populate every other form that requires the client's full name.

On a more complex level, however, the Subject's entire income profile could be input into the database associated with eligibility determination, enrollment, and management system 100 of FIG. 1 and every form that requires income information would be filled out appropriately and automatically. This feature of eligibility determination, enrollment, and management system 100 of FIG. 1 increases efficiency and decreases the redundancy that is experience when completing many applications by hand. Though a mortgage broker may not need a feature that gives the ability to apply for multiple mortgages for one client, a school counselor helping to enroll students in several scholarships may find the ability to handle multiple applications very desirable or even an absolute necessity.

Another feature of enrollment step 320 that helps to increase efficiency is the ability to take a complex application and convert it into an easy-to-understand Interview. For example, if a mortgage broker did not have eligibility determination, enrollment, and management system 100 of FIG. 1, the broker would have to fill out all of his clients' applications by hand or he would have to hire someone and train him to understand the applications thoroughly so that he would complete the forms correctly. With eligibility determination, enrollment, and management system 100 of FIG. 1, however, questions within the Enrollment Interviews could be configured in an easily understood fashion so that anyone could complete the Interview. The Interview is a simple and functional method of collecting data. In certain preferred embodiments of the present invention, it is even contemplated that the applicant or Subject will conduct each Interview on their own, interacting independently with eligibility determination, enrollment, and management system 100 of FIG. 1.

Once enrollment step 320 has been completed, the forms necessary for actually submitting an application or registering for a program or programs can be completed by forms mechanism 228 of FIG. 2. The forms generation process may be termed “Rendering” and is a process that takes the information gathered from the Subject during Enrollment process and embeds it onto a form or some other type of electronic destination source. Although there are many types of possible destination sources, PDF documents are a preferred implementation since PDF documents are readily accepted for use with most operating systems.

The Rendering process, in practice, can be further explained in the context of the mortgage example. Once the broker has finished a client's enrollment interview, eligibility determination, enrollment, and management system 100 of FIG. 1 will embed the Subject's name into the blank mortgage application. In many forms, there may be multiple instances or occurrences of the Subject's name and, in each instance, the information gathered during the interview will be extracted from the database and used to populate the name Subject's name into the mortgage application in the appropriate locations. Similarly, other redundant information may be entered across multiple forms that make up an application package or packages for a wide variety of programs.

After the required form or forms are completely filled out, the mortgage company can then use the completed application for any relevant purpose. For example, the completed forms can be sent via email to the Subject so they can sign the completed application. Alternatively, if the Subject digitally signed the document the mortgage company can start the loan process with the bank.

In this example, eligibility determination, enrollment, and management system 100 of FIG. 1 allows the form to be printed and kept as a completed mortgage application in hand ready to submit or store. This is not the only way eligibility determination, enrollment, and management system 100 of FIG. 1 can submit data. Eligibility determination, enrollment, and management system 100 of FIG. 1 can also be configured to submit and complete a web-based application using the same information collected in an enrollment interview. This ability frees eligibility determination, enrollment, and management system 100 of FIG. 1 and the user from solely relying on paper applications.

The programmatic architectural structure described herein not only provides a modular platform for implementing eligibility determination, enrollment, and management system 100 of FIG. 1, but also provides a stable platform suitable for building additional modules and/or software applications and provides an extensible framework for enhancing eligibility determination, enrollment, and management system 100 of FIG. 1 in the future. In addition, by providing a plurality of middleware services and management modules, eligibility determination, enrollment, and management system 100 of FIG. 1 may be upgraded and improved as necessary and or desired to offer additional capabilities, such as quickly adapting the system to include new programs and new eligibility requirements.

Additionally, application, back-end, and web user interfaces may comprise one or more user customizable web-based templates that can be utilized to create one or more user interfaces for accessing eligibility determination, enrollment, and management system 100 of FIG. 1. This includes the creation and implementation of billing and other back-office related functions. By accessing application, back-end, and web user interface 310, the user of eligibility determination, enrollment, and management system 100 of FIG. 1 can insert, retrieve, update, sort, and review the various information stored in and made available by eligibility determination, enrollment, and management system 100 of FIG. 1. This information may be provided in virtually any form desired and requested by the users such as reports, graphs, charts, etc.

Referring now to FIG. 1, FIG. 2, FIG. 3, and FIG. 4, a basic process flow for eligibility determination, enrollment, and management system 100 of FIG. 1 is described. In the most preferred embodiments of the present invention, the user will access eligibility determination, enrollment, and management system 100 of FIG. 1 via a standard web browser such as Microsoft Internet Explorer, Netscape Navigator, Mozilla Firefox, Safari, or the like. The web browser can be operated by any standard methodology such as using desktop computer 170, laptop computer 180, or PDA 190 of FIG. 1. The user can use the web browser to access eligibility mechanism 226, enrollment mechanism 227, and forms mechanism 228. The various software mechanisms shown in FIG. 2 are used by various users to input data into and retrieve data such as applications, forms, reports and the like from database 223 of FIG. 1.

Eligibility determination, enrollment, and management system 100 of FIG. 1 will evaluate the data provided during Interviews using “Qualifying Expressions.” Qualifying Expressions are built using a specific language developed using Boolean algebra. Boolean algebra is a language that evaluates logical expressions as either “True” or “False.” Eligibility determination, enrollment, and management system 100 of FIG. 1 expands this evaluation to allow Qualifying Expression to use True, False, or Maybe. Eligibility determination, enrollment, and management system 100 of FIG. 1 takes the values stored in the Subject Properties from a Subject Property Data File and compares them to constant values.

For example, where a Qualifying Expression may be used to evaluate the status of the Subject Property “Home State” contains the value “Florida”. In this example, the Qualifying Expression will be evaluated as “True,” if the Subject Variable “[Home State]” is equal to “Florida”. If the Subject Variable “[Home State]” was “Alabama” the Qualifying Expression in would be evaluated as “False.” By creating logical and mathematical expressions that can calculate these kinds of Qualifying Expressions, eligibility determination, enrollment, and management system 100 of FIG. 1 eliminates the need for the person completing the interview to make any complex calculations that, if done incorrectly, could mean the difference between qualifying and not qualifying for an Outcome. This also allows for rapid prioritization of Qualifying expressions and, by extension, allows for optimization of not only the correct questions to be asked but also selecting the optimal order in which the questions should be asked, thereby arriving at the most probable Outcomes in the most efficient manner possible.

In order to evaluate a Qualifying Expression, eligibility determination, enrollment, and management system 100 of FIG. 1 requires a Subject Property Data File to supply the raw information. That information can then be used to evaluate multiple Qualifying Expressions relevant to the Subject Data supplied. In the most preferred embodiments of the present invention, and in order to facilitate their use, each Qualifying Expression is given a unique name that should not be duplicated. However, once a name is given to a given Qualifying Expression, it can then be used in other Qualifying Expressions or can be mapped to an Outcome.

Qualifying Expressions can also be used to complete mathematical calculations. For example, a mortgage applicant may have completed a Qualification Interview that asked for the monthly amounts of his employment income, social security income, etc. The mortgage programs in the Outcome Set, however, only require the value of his total monthly income. A qualifying expression could take each of his income values and plug them into an expression formula to generate the total sum, such as “Total_Income.” This value would then be compared to other values or Qualifying Expressions. For example, the “Total_Income” Qualifying Expression could be reused, as a Sub-Expression in the Qualifying Expression “Income_Expression.” In this same Qualifying Expression,“Total_Income,” which is the Subject's employment and Social Security income added together, is compared to see whether it is less than the value “1000.” If, in this example, the employment number were equal to “100” and the Social Security number were “90,” the Qualifying Expression “Income_Expression” would be evaluated or resolved to “True” because the sum of “100” and “90” equals “190,” is less than “1000.” The “Income_Expression” would have evaluated to “False”, however, if the sum of both Variables in “Total_Income” was over “1000.”

By creating logical and mathematical expressions that can calculate these kinds of Qualifying Expressions, eligibility determination, enrollment, and management system 100 of FIG. 1 eliminates the need for the person completing the interview to make any complex calculations that, if done incorrectly, could mean the difference between qualifying and not qualifying for a potentially viable Outcome.

Qualifying Expressions can also be mapped to one or more Outcomes. For example, in FIG. 3, the Initial Outcome Set is made up of ten different potential Outcomes. In this case, the programs are labeled Programs 1 through 10. The application of Qualifying Expressions to Outcomes is clearer when certain characteristics, which are called “Outcome Attributes,” are included in the process of Outcome Filtering.

Using the information in FIG. 3, eligibility determination, enrollment, and management system 100 of FIG. 1 can be configured for an individual Outcome. In this example, “Program 1” has three Outcome Attributes associated with it: namely, state, county, and name. Each Outcome Attribute has a value and a data type. The value is the characteristic of the Outcome and the data type is the type of the value. In this case “Program 1” is a transportation assistance program that is available to qualified individuals that live in Broward County, Florida.

Eligibility determination, enrollment, and management system 100 of FIG. 1 filters Outcomes based on the values of Outcome Attributes. In this example, after filtering based on the Outcome Attributes of Program 1, the Initial Outcome Set is filtered by the Outcome Attribute “state” where the state is equal to “FL”. After this filtering takes place, the only Outcomes that are left are programs in Florida. Next, the second filter that refines the Outcome Set is applied. In this case, the requirement is that each Outcome be in Broward County. Within this example, the filtering process has reduced Outcome Set by 50%. The Filtering process is, essentially used to identify and select only those Outcomes that belong to Broward County and to the state of Florida. Everything else is eliminated in the filtering process.

Outcome Filtering is an elegant concept that reduces the Initial Outcome Set before applying any Qualifying Expressions. In application, there may be hundreds of programs located in places around the United States. All of these programs would share the same attributes, state and county, while maintaining different values for those attributes. Once the specific state and county for every program is known, eligibility determination, enrollment, and management system 100 of FIG. 1 can drastically reduce the Initial Outcome Set and can start the Outcome Qualification process with a smaller Initial Outcome Set. With a smaller Outcome Set at the onset of Outcome Qualification, eligibility determination, enrollment, and management system 100 of FIG. 1 would require much less computer memory to handle all of the programs and could, in turn, operate much more quickly and efficiently.

Given a set of Outcomes with vehicle specifications used as attributes (e.g., make, model, year, engine type, tire size, power steering, grade of gas required, sound system, GPS, radio model, and type of interior), additional insight can be obtained. All of these vehicle specifications could be defined as valid attributes. Using this specific set of Outcome Attributes, eligibility determination, enrollment, and management system 100 of FIG. 1 could filter through an Outcome Set of vehicles and find an exact price match depending on the attributes values specified by the user. With less attributes defined to the Outcomes, however, eligibility determination, enrollment, and management system 100 of FIG. 1 would not be able to refine the Outcomes as closely. Essentially, the amount of Outcome Attributes tied to an Outcome is generally proportional to the accuracy of Outcome Filtering.

Given this application of Outcome Filtering, it is also possible to combine it with Subject Properties to achieve even greater flexibility and efficiency. Outcome Filtering can take a Subject Property, as is, from a Subject Data File and compare it to an Outcome Attribute. Therefore an Outcome Set can be filtered using a Subject's Subject Properties. Now the Subject's Subject Property “Home State” can be compared with the Outcome Attribute “state” to further filter the Outcome Set. As powerful as this method is, Outcome Filtering is not the only way to reduce the number of Outcomes in an Outcome Set. Outcome Qualification may also use Derived Properties to compare to Subject Properties in order to reduce the number of Outcomes in an Outcome Set.

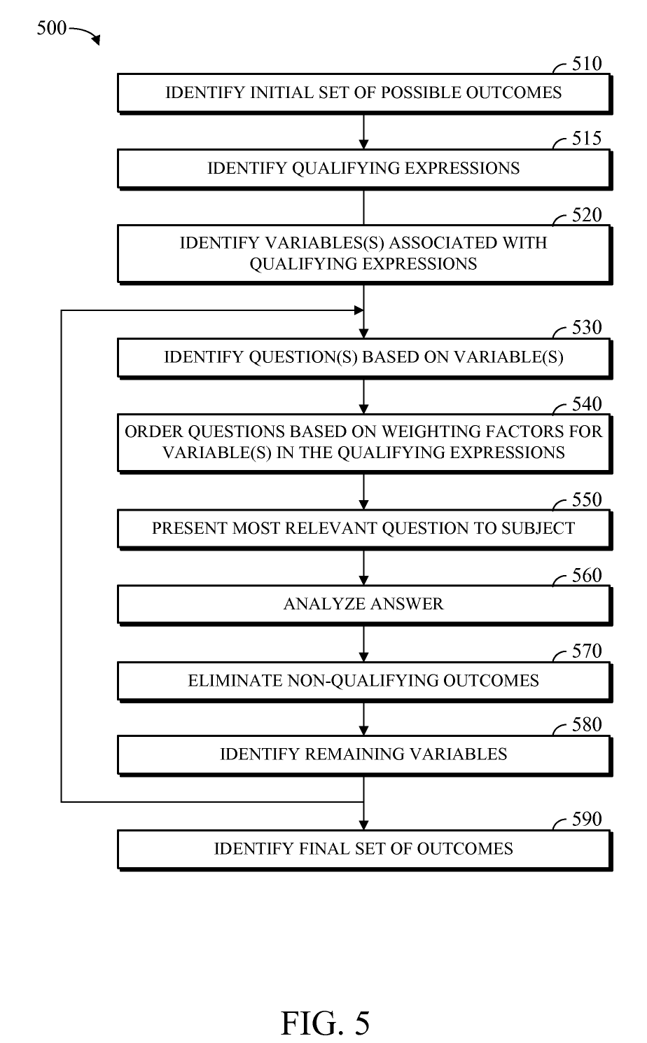

Referring now to FIG. 5, a method 500 for rapidly and efficiently identifying and determining the most successful outcomes for a given set of circumstances is set forth. In this case, method 500 is a more generalized approach to the methodology and system components described in FIG. 1-FIG. 4 above. As shown in FIG. 5, the first step is to identify the initial set of possible outcomes (step 510). This would include, for example, identifying all possible colleges scholarships that may be available in the database of college scholarships. Next, for each outcome, there will be a qualifying expression associated with each potential outcome and these qualifying expressions should be identified (step 515). Each qualifying expression will contain a series of variables that are used to determine the necessary qualifications for qualifying for a given outcome (scholarship). By evaluating the variables in the qualifying expression for each outcome, it can be determined whether or not the candidate qualifies for the selected scholarship. The goal is to get to the end result as quickly and efficiently as possible. To that end, in the most straightforward embodiment of the present invention, the variables are weighted in accordance with their frequency of appearance in the qualifying expressions for the potential outcomes. However, in the most preferred embodiments of the present invention, a variable's weight may be calculated as a determination made based on the number of times a variable appears in all of the qualifying expressions and based on the number of other variables it can eliminate in the consolidated expression tree, taking into account the current state of other variables that have known values.

With the relevant qualifying expressions identified, the variables used in each qualifying expression can be identified (step 520). Since each variable in each of the qualifying expressions is associated with exactly one question, the relationship between variables and questions is significant. The same variable (related to a specific question) may be used in a plurality of qualifying expressions. For example, there may be a series of scholarships available to an applicant (subject), where an important qualification for each of the scholarships is the ethnicity of the applicant. Each qualifying expression for each potential scholarship (e.g., outcome), will include the specific variable used to determine the ethnicity of the candidate. In other words, each variable may be used in multiple qualifying expressions, but each variable is used to resolve a single question that will be posed to the subject. The variables are mapped to the qualifying expressions and the questions.

With all possible variables having been identified, all of the questions associated with those variables can also be identified (step 530). Using the total number of times a given variable is used will allow the most important (i.e. discriminating) question to be identified. The variable that is the most commonly used in the qualifying expressions for the possible outcomes can be used to order the questions (step 540). Since the most discriminating variable will be the one that appears in the most qualifying expressions, the question associated with that variable should be the most relevant question to ask the subject or candidate (step 550). The answer to the most relevant question can be used to identify or eliminate the highest number of potential outcomes, thereby decreasing the number of questions that must be asked in order to reach the final answer.

Once the candidate answers the most discriminating question, the answer to that question can be analyzed (step 560) by inserting the answer in the appropriate variable for each of the qualifying expressions and determining which possible outcomes can be eliminated from the initial outcome set (step 570). The elimination of certain outcomes from the pool of possible outcomes may also result in a reduction of the number of variables used in the remaining potential outcomes. The remaining variables can then be identified (step 580) and this process will be repeated until the final set of applicable outcomes (scholarships) has been identified (step 590). Using this dynamic and iterative process, the most relevant questions are always asked first, thereby reducing the universe of potential outcomes as quickly as possible, thereby arriving at the solution set of actual outcomes as rapidly and efficiently as possible. The final solution set consists of the “acceptable” outcomes, e.g., those outcomes for which the candidate is qualified and eligible to participate in.

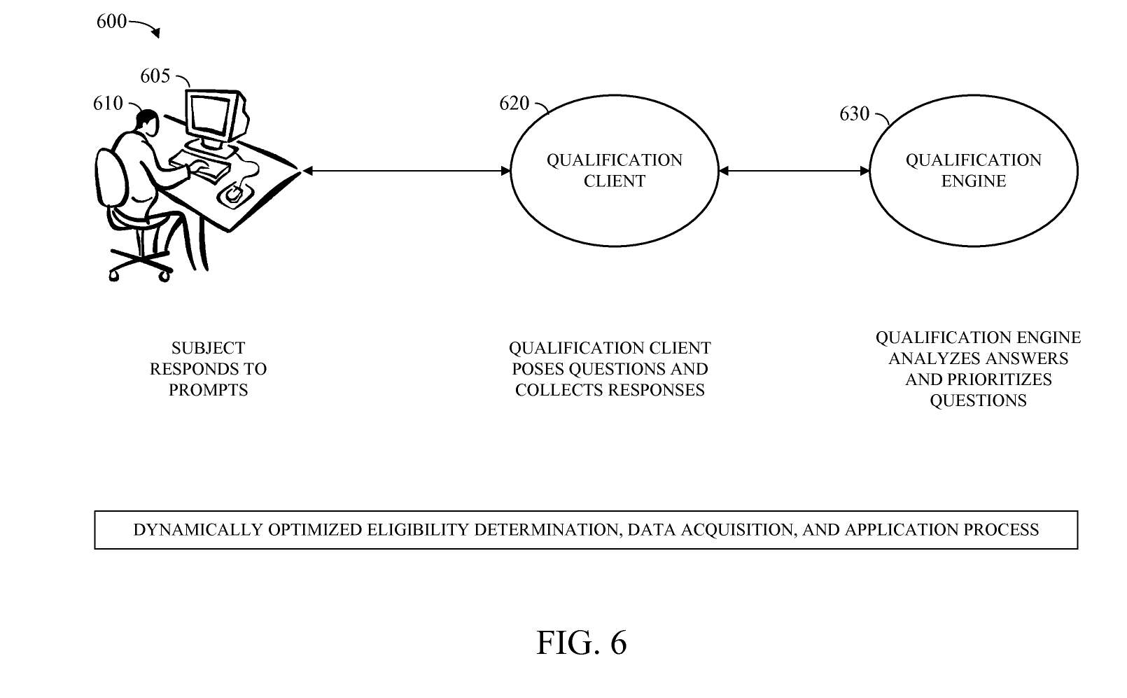

Referring now to FIG. 6, a schematic diagram for a dynamic qualification process 600 illustrates a more specific implementation of method 500 described in FIG. 5. As shown in FIG. 6, a qualification client 620 and a qualification engine 630 are used to interact with a subject 610 during the qualification and application process. It should be noted that qualification client 620 and a qualification engine 630 can be considered to be part of eligibility mechanism 226 of FIG. 2 and an overall part of computer-based benefits eligibility determination, enrollment, and management system 100 of FIG. 1. Similarly, computer 605 can be considered to be either desktop computer 170 and/or laptop computer 180 and all of the components of FIG. 6 are within the framework of computer-based benefits eligibility determination, enrollment, and management system 100 of FIG. 1.

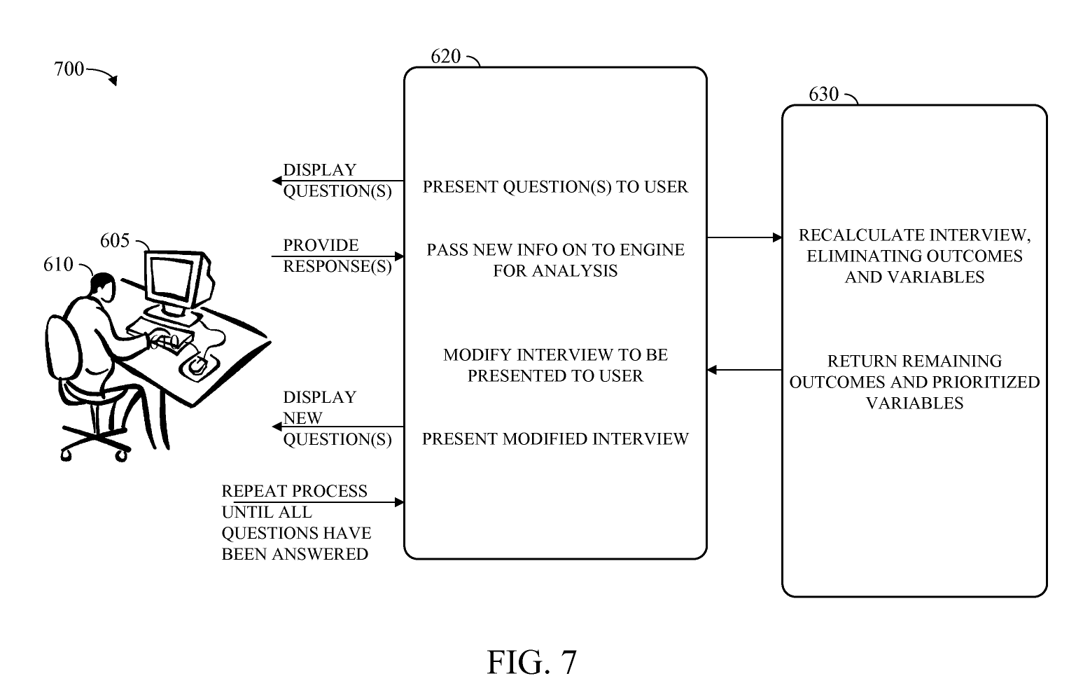

As shown in FIG. 6 and FIG. 7, subject 610 will interact with via computer 605 to view and respond to prompts and questions posed by qualification client 610 and to provide specific input to qualification client 610 by responding to the prompts and questions posed by qualification client 610. Qualification client 610 is the software interface to computer-based benefits eligibility determination, enrollment, and management system 100 of FIG. 1.

Qualification engine 630 interacts with qualification client 620. Qualification client 620 receives the responses of subject 610 and transmits these responses to qualification engine 630. Qualification engine 630 analyzes the responses provided by subject 610 and, based upon the provided responses, evaluates the qualifying expressions, determines the subset of questions that remain to be asked, and orders the remaining questions for presentation to subject 610. This process involves eliminating outcomes and variables based on the input provided by subject 610 to qualification client 620. By eliminating invalid outcomes, the variables corresponding to those outcomes can also be eliminated. Once the reduced set of outcomes has been identified by qualification engine 630, the relevant variables are identified and, based on the occurrence of the variables, the most relevant question or questions can be identified. These questions are then used by qualification client 620 to reformulate the interview and pose additional questions to subject 610. In this fashion, the number of questions that must be asked and the amount of data that must be collected can be minimized to the extent practicable. Those skilled in the art will recognize that qualification client 620 and qualification engine 630 may be parts of a singular computer program and that the distinctions made herein are for illustrative purposes only.

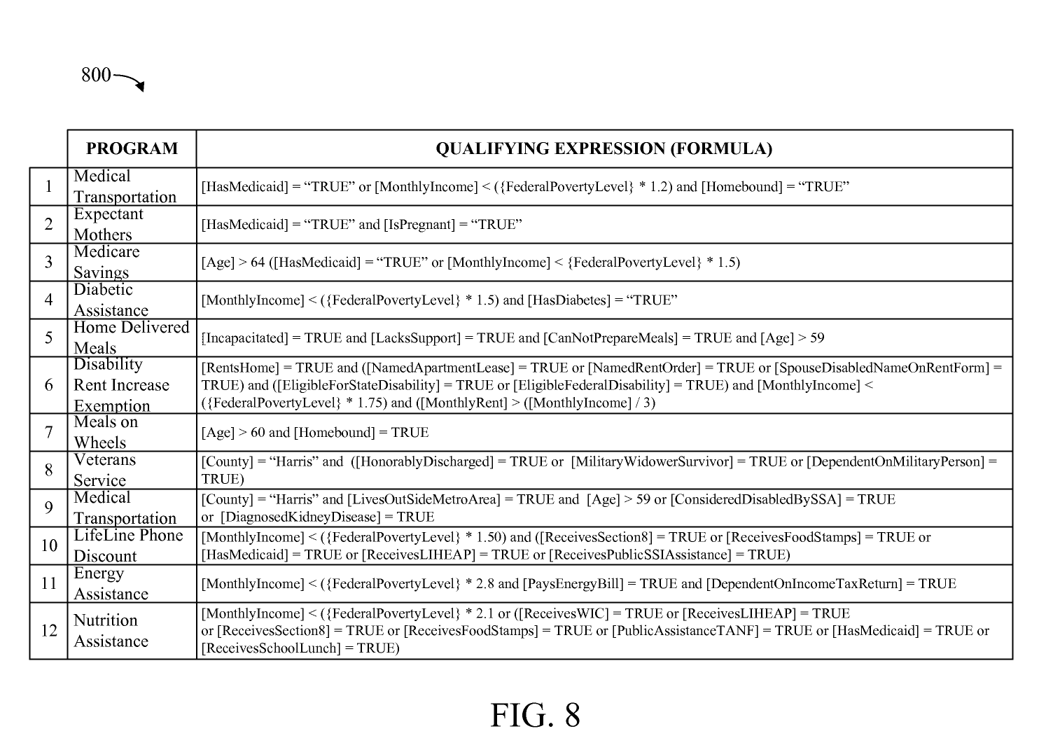

Referring now to FIG. 8, table 800 illustrates a number of potential outcomes (social service programs) that may be under consideration for a given subject (applicant). As shown in FIG. 8, there are 12 potential social service programs for which an applicant may apply. Associated with each of these 12 programs is a qualifying expression that establishes the conditions under which an applicant is eligible to receive the benefits of the associated program. Each of the 12 qualifying expressions is actually a mathematical expression, containing one or more variables. Each of the variables corresponds to a single question.

During the qualification interview process, the applicant will respond to one or more questions. The answers to the questions provided by the applicant will be mapped back into the appropriate variable for the associated qualifying expression and each of the qualifying expressions can be evaluated as “true,” “false,” or “maybe.” For each qualifying expression where the qualifying expression is evaluated as “false,” the applicant is ineligible for the social service program associated with the qualifying expression. For each qualifying expression where the qualifying expression is evaluated as “true,” the applicant is eligible for the social service program associated with the qualifying expression. For each qualifying expression where the qualifying expression is evaluated as “maybe,” the applicant may be eligible or ineligible for the social service program associated with the qualifying expression but additional information will be needed in order to make a final determination.

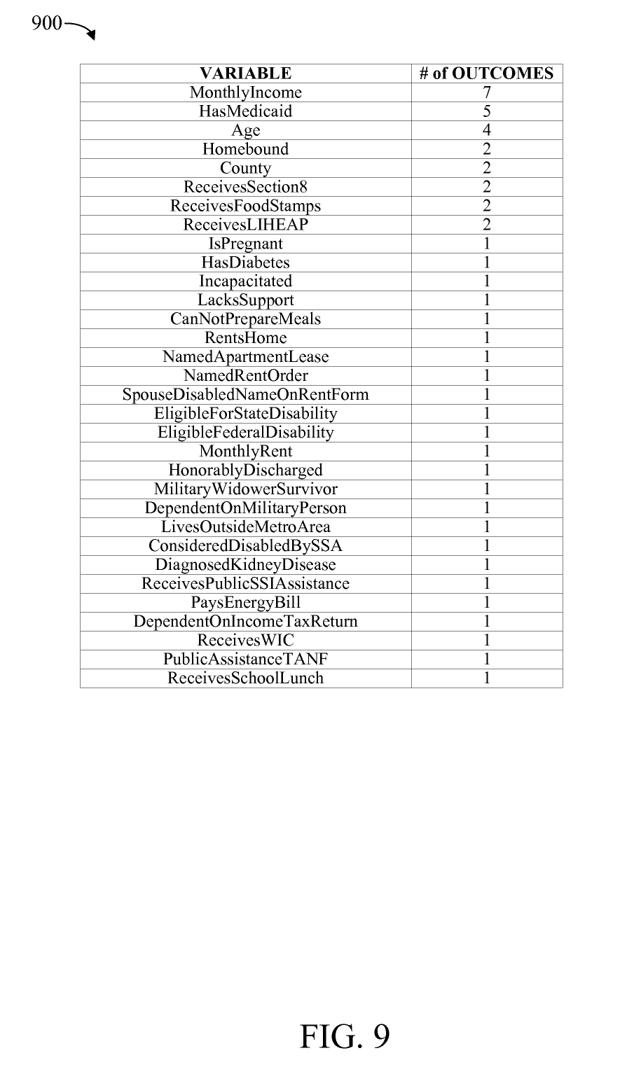

By viewing the qualifying expressions shown in FIG. 8, additional details of the invention can be explained. For example, reviewing the qualifying expressions for outcomes 1, 3, 4, 6, 10, 11, and 12, it is apparent that the variable [MonthlyIncome] is used in each qualifying expression. By examining each of the qualifying expressions shown in table 800, a tabular listing of all variables and the appropriate weighting factor (e.g., frequency of appearance for this example) of the variables can be created. This tabular listing is shown in FIG. 9 as table 900.

Referring now to FIG. 9, each variable in all of the qualifying expressions shown in FIG. 8 have been listed in table 900, along with the frequency of appearance based on the number of qualifying expressions in which the variable appears. MonthlyIncome, which appears seven time, is the most frequently appearing variable and, for this example, the most important or discriminating variable. All other variables appear less frequently and, therefore, are accorded less weight. Based on this weighting determination, the question associated with the most commonly appearing variable is presented as the first question in the qualification interview process. Once the answer to the question is provided, each relevant qualifying expression can be mathematically resolved and evaluated. In the case of MonthlyIncome, the associated question would be “What is your Total Monthly Income before taxes? and the answer might be “$2,000.” The number $2,000 is twice the Federal Poverty Level (all constants, such as Federal Poverty Level, are entered as values in the appropriate qualifying expressions and may be drawn from an external lookup table).

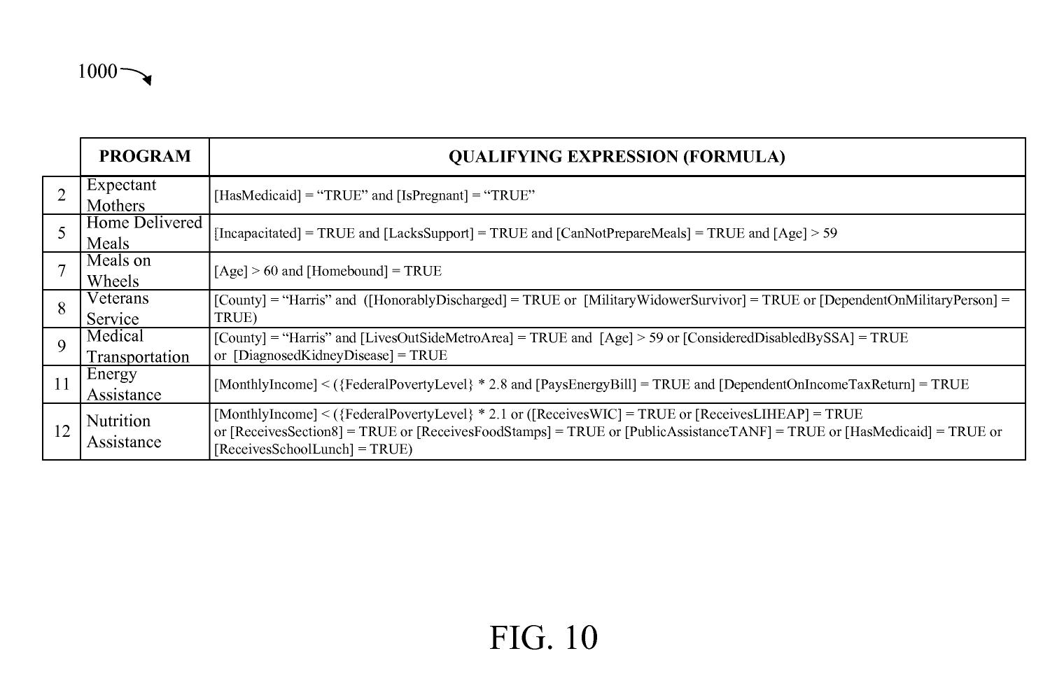

Given the response from the subject, five potential outcomes (numbers 1, 3, 4, 6, and 10) are automatically eliminated from further consideration because the response indicates that the monthly income exceeds the pre-established income for the various outcomes. The universe of potential outcomes has now been reduced to seven and table 800 can be reconfigured. The resulting table for the remaining potential outcomes is shown in FIG. 10 as table 1000.

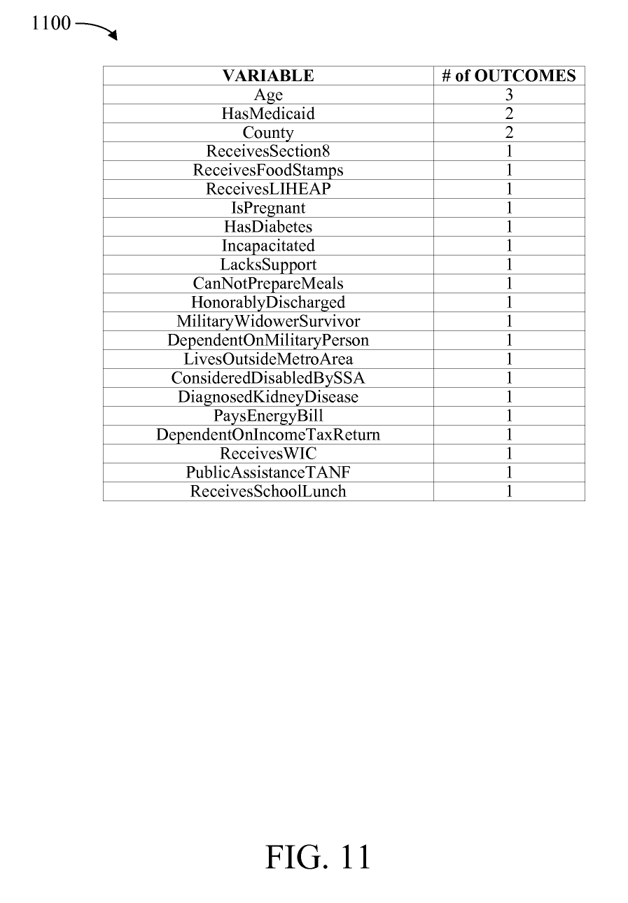

In addition to eliminating five potential outcomes, a significant number of variables can also be eliminated from consideration because the qualifying expressions containing those variables have now been eliminated from consideration. This allows table 900 to be reconfigured, eliminating the invalid variables and reordering table 900 based on the frequency of appearance for the remaining variables. This reconfigured table is shown in FIG. 11 as table 1100. It should be noted that the frequency number for many of the variables has been reduced, reflecting the deletion of qualifying expressions containing that variable. For example, in table 800, “Age” had a frequency of four, based on its appearance in four qualifying expressions. However, in table 1100, “Age” now has a frequency of three, given that one of the qualifying expressions where “Age” appeared has now been removed from consideration.

Given that “Age” is now the most discriminating variable remaining, the next question posed to the subject is “What is your age?” and the response is “35.” The number 35 is returned for the variable “Age” and each of the remaining qualifying expressions can be resolved and evaluated using 35 in the mathematical formula representing the qualifying expression. In this case, an addition three outcomes (5, 7, and 9) can now be eliminated from further consideration. This leaves four potential outcomes remaining for further consideration.

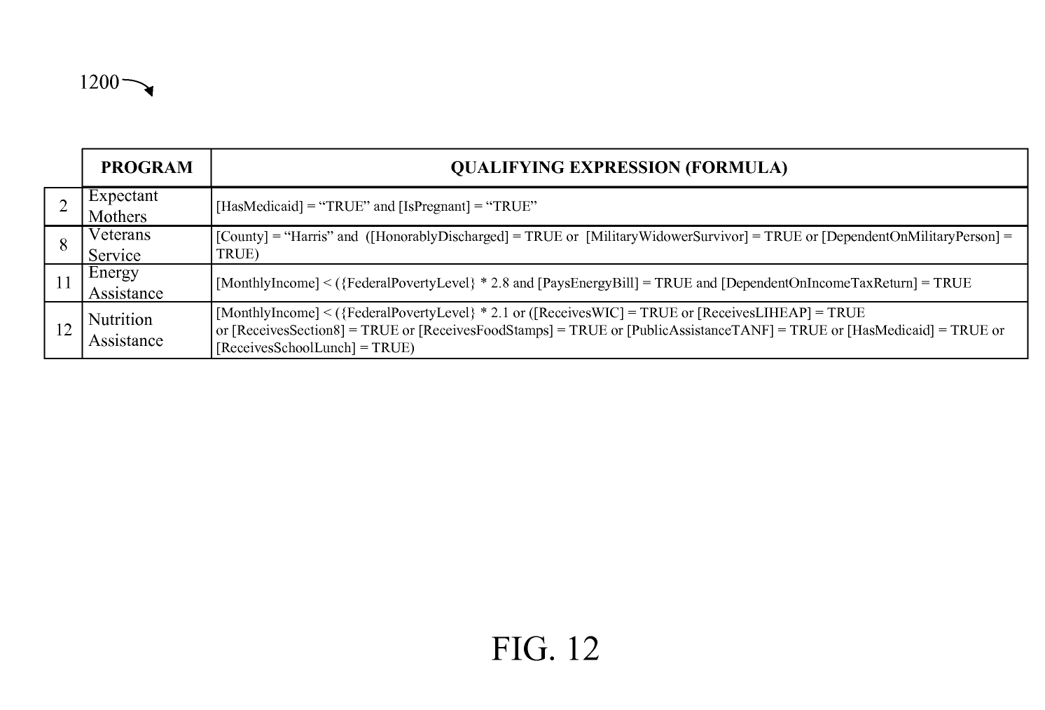

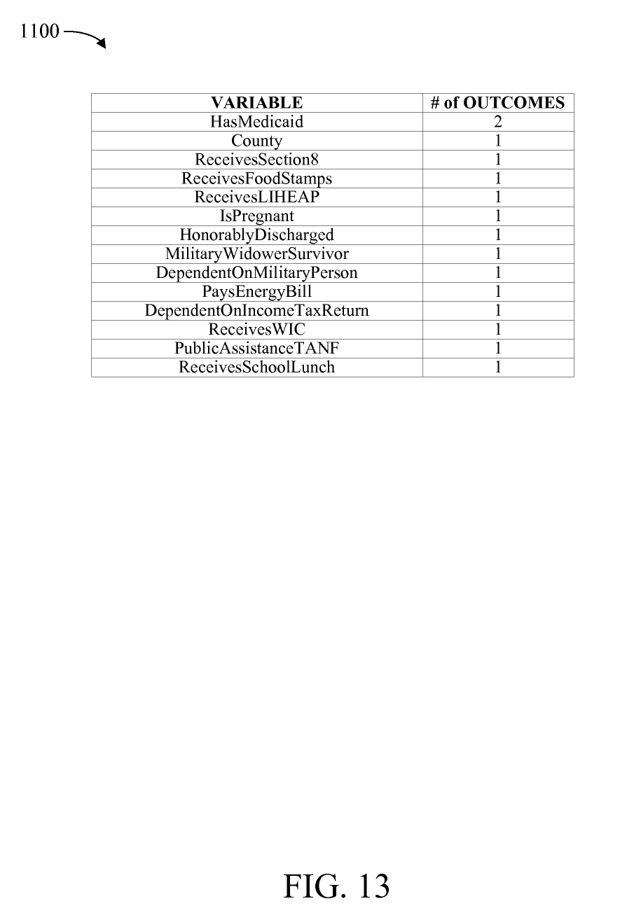

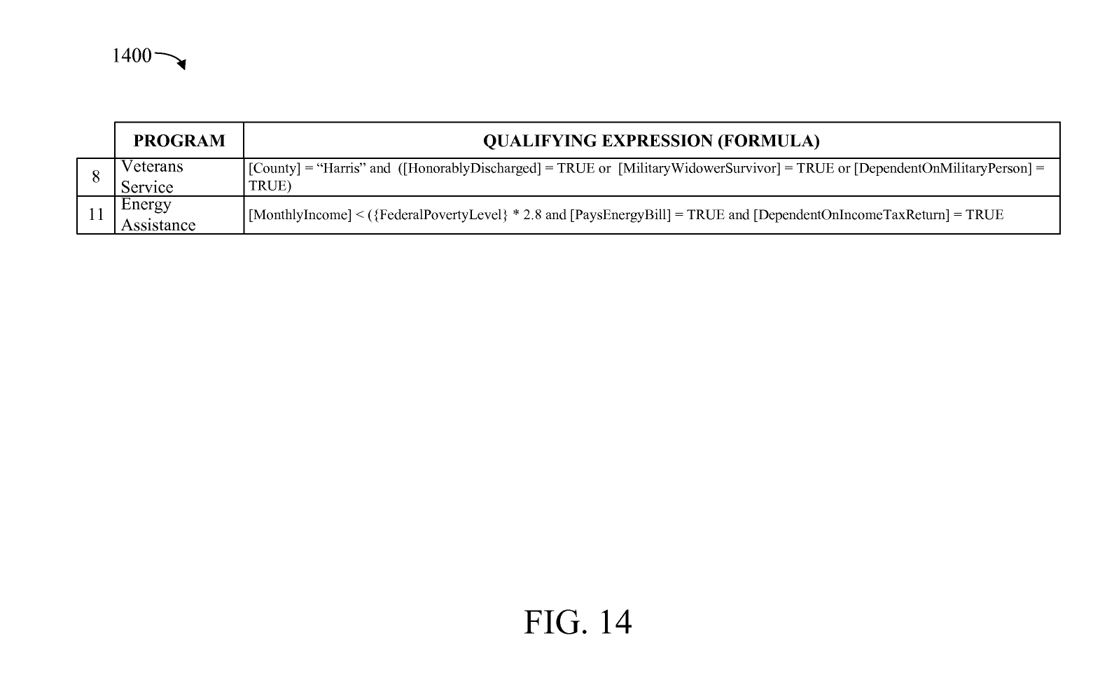

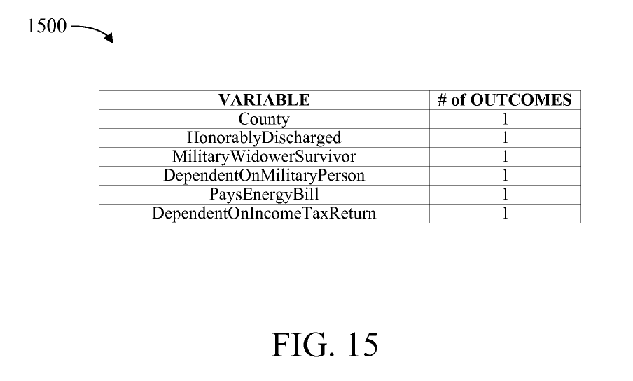

As with previous iterations, it is now possible to evaluate the remaining potential outcomes and remaining variables, reconfiguring table 1000 and table 1100 based on the remaining variables. The results of this reconfiguration are shown as table 1200 and table 1300 in FIG. 12 and FIG. 13, respectively. As shown in table 1300, “HasMedicaid” is now the most discriminating variable and, accordingly, the next question posed to the applicant is “Are you currently covered by Medicaid?” and the answer is “No.” Given this response, the tables are reconfigured once again, with the results being shown in tables 1400 and 1500 of FIG. 14 and FIG. 15, respectively.

At this point in time, the remaining variables, shown in table 15 of FIG. 15, have equal weight. Accordingly, each of the remaining variables can be resolved by asking the associated questions in order. In this example, the next question would be “What county do you live in?” and the answer would be “Jefferson.” Using this response, outcome eight can be eliminated from further consideration and the associated variables that are not used in other qualifying expressions can be disregarded. This leaves only one potential outcome remaining and two variables yet to be resolved. The appropriate questions “Do you currently pay an energy bill?” and “Do you currently depend on your income tax return to pay your bills?” are both answered in the affirmative, and the subject has now been qualified for participation in social service program number 11, related to assistance in paying utility bills.

It is important to note that determining the order of questions presented to be presented to the applicant based solely on the frequency of variables is one of the most simplistic implementations of the preferred embodiments of the present invention. Other, more sophisticated approached may be used to determine the most discriminating variable and, accordingly, the most appropriate question to be presented to a given subject at any given time. For example, the most discriminating variable might be determined by weighting the variables in accordance with the number of times the variable appears in an equation by itself, with the Boolean operator “and” as the mathematical operation. In this case, it may be possible to eliminate a significant number of qualifying expressions based on a single variable. Conversely, if a variable is only one of many variables and is coupled by the Boolean operator “or” to a number of other mathematical expressions in a single qualifying expression, the resolution of that single variable may not provide for the elimination of any qualifying expressions, even though the variable appears in every qualifying expression.

It should be noted that after the qualification interview process has been completed, enrollment mechanism 227 and forms mechanism 228 can be invoked to finalize the enrollment process. By using the information gathered during the initial interview process as well as the qualification interview, all or substantially all of the required information will have already been gathered and the enrollment process can be completed without undue delay. The forms necessary for enrollment can then be printed, faxed, or automatically and electronically transmitted to the appropriate agency or organization.

In addition to frequency of appearance for the variables contained in the qualifying expression, the order of selection for questions may be determined by other weighting factors (e.g., statistical weighting factor and/or geographic weighting factor). For example, the questions may be ordered by giving precedence to questions from the statistically most “accepting” programs (e.g., those programs that have a historical and statistically significant acceptance rate that is higher than other similar programs). Further, questions may be ordered by taking geographic proximity into account (e.g., the physical location of the candidate may be determined and then the eligibility questions from programs that are offered by agencies or organizations in the same geographic area may also be given higher priority than the eligibility questions from programs offered by agencies or organizations that are more geographically remote. Additionally, a combination of some or all of these various weighting factors may be employed to further identify and present the most appropriate questions in the most appropriate order for a given candidate.

Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing one or more preferred exemplary embodiments of the invention, it being understood that various changes may be made in the function and arrangement of elements described in the exemplary preferred embodiment without departing from the spirit and scope of the invention as set forth in the appended claims.

1. An apparatus comprising:
at least one processor;
at least one memory coupled to said at least one processor;
at least one database residing in said at least one memory; and
a eligibility mechanism residing in said memory, said eligibility mechanism being configured to identify a first relevant question from a plurality of questions contained in said at least one database based on at least one weighting factor, said eligibility mechanism being configured to pose said first relevant question to at least one candidate for participation in a plurality of benefits programs and to receive an answer to first relevant question from said at least one candidate, said eligibility mechanism being configured to eliminate at least one of said plurality of benefits programs based on said answer, said eligibility mechanism being configured to pose at least a second relevant question to said at least one candidate based on said at least one weighting factor.

2. The apparatus of claim 1 further comprising an enrollment mechanism residing in said memory, said enrollment mechanism being configured to:
gather a plurality of additional responses from at least one candidate in response to said plurality of questions; and
select additional questions from said plurality of questions where said additional questions are selected to provide information necessary for participation in a program related to said first relevant question and said at least a second relevant question.

3. The apparatus of claim 2 further comprising a forms mechanism, said forms mechanism being configured to render one or more forms containing at least some information derived from said enrollment mechanism.

4. The apparatus of claim 3 wherein said forms mechanism is configured to automatically enroll at least one candidate in at least one benefits program using said at least some information derived from said enrollment mechanism.

5. The apparatus of claim 1 wherein said eligibility mechanism is configured to:
identify a plurality of potential outcomes from said at least one database;
identify at least one qualifying expression associated with each of said plurality of potential outcomes;
identify a plurality of variables associated with each of said plurality of qualifying expressions, wherein each of said plurality of variables is associated with a question, there being at least one question for each of said plurality of variables, there being a plurality of questions;
determine a most common variable from among said plurality of variables, based on the number of times each of said plurality of variables appears in each of said at least one qualifying expressions; and
identify said most common question from among said plurality of questions, said most common question being associated with said most common variable.

6. The apparatus of claim 1 further comprising:
an email server residing in said at least one memory;
a fax server residing in said at least one memory; and
a security mechanism residing in said at least one memory.

7. The apparatus of claim 1 wherein said at least one weighting factor comprises at least one of a statistical weighting factor and a geographic weighting factor, said geographic weighting factor being derived by identifying a geographic location for said at least one candidate and a geographic location for each of said plurality of benefits programs, said statistical weighting factor being derived from a historical acceptance rate for each of said plurality of benefits programs.

8. The apparatus of claim 1 wherein said at least one weighting factor comprises:
a geographic weighting factor, said geographic weighting factor being derived by identifying a geographic location for said at least one candidate and a geographic location for each of said plurality of benefits programs;
a statistical weighting factor, said statistical weighting factor being derived from a historical acceptance rate for each of said plurality of benefits programs; and
a frequency of occurrence weighting factor, said frequency of occurrence weighting factor being derived from the frequency of appearance of a plurality of variables contained in a plurality of qualifying expressions, with each of said plurality of qualifying expressions being related to at least one relevant question.

9. A computer-implemented method of eligibility determination, said method comprising the steps of:
a) selecting a set of questions from a plurality of questions, said set of questions being related to a plurality of potential benefit programs;
b) using at least one weighting factor to select a most relevant questions from said set of questions;
c) presenting said most relevant question to at least one candidate for participation in said plurality of potential benefit programs, thereby creating a set of relevant questions;
d) using a response to said a relevant question to eliminate at least one of said plurality of potential benefit programs, thereby creating a plurality of relevant responses to said plurality of relevant questions;
e) repeating steps b-d, thereby adding additional relevant questions to said set of relevant questions and additional responses to said plurality of relevant responses until all relevant questions from said set of questions have been presented to said at least one candidate;
f) identifying at least one benefit program from said plurality of benefit programs for which said at least one candidate is eligible, based on said plurality of responses to said plurality of relevant questions; and
g) displaying information relative to said at least one benefit program one at least one of a computer display, a form printed by a computer printer, and a facsimile machine printout.

10. The method of claim 9 further comprising the steps of:
h) acquiring a plurality of additional data elements from said at least one candidate, said plurality of additional data elements being necessary for participation in said at least one benefit program;
i) using said plurality of data elements to render at least one form required for candidate participation is said at least one benefit program; and
j) displaying said at least one form on at least one of a computer screen, a printed form, and a facsimile printout.

11. The method of claim 9 wherein said step of identifying at least one benefit program from said plurality of potential benefit programs comprises the steps of:
identifying at least one qualifying expression associated with each of said plurality of benefit programs;
identifying a plurality of variables associated with each of said qualifying expressions, wherein each of said plurality of variables is associated with a question from said plurality of questions, there being a question for each of said plurality of variables;
identifying a most common variable from among said plurality of variables, based on the number of times each of said plurality of variables appears in each of said at least one qualifying expressions;
determining a most common question from among said plurality of questions, said most common question being associated with said first most common variable; and
identifying said most common question as said most relevant question.

12. The method of claim 9 wherein said at least one weighting factor comprises a statistical weighting factor, said statistical weighting factor being derived from a historical acceptance rate for each of said plurality of benefit programs.

13. The method of claim 9 wherein said at least one weighting factor is based on the number of times one of said plurality of variables appears in a plurality of qualifying expressions and on the number of said plurality of variables can eliminated from further consideration when the value of said one of said plurality of variables is evaluated.

14. The method of claim 9 wherein said at least one weighting factor comprises a geographic weighting factor, said geographic weighting factor being derived by identifying a geographic location for said at least one candidate and a geographic location for each of said plurality of benefit programs.

15. The method of claim 9 wherein said at least one weighting factor comprises at least one of a statistical weighting factor and a geographic weighting factor, said geographic weighting factor being derived by identifying a geographic location for said at least one candidate and a geographic location for each of said plurality of benefits programs, said statistical weighting factor being derived from a historical acceptance rate for each of said plurality of benefits programs.

16. The method of claim 9 further comprising the step of automatically enrolling said at least one candidate in said at least one benefit program using plurality of additional data elements from said at least one candidate.

17. The method of claim 10 wherein said step of displaying said at least one form on at least one of a computer screen, a printed form, and a facsimile printout comprises the steps of:
filtering a plurality of forms and selecting said at least one form from a plurality of forms, based on said at least one benefit program, each of said plurality of forms being associated with at least one of a plurality of benefit programs;
selecting specific data elements from said plurality of data elements where said specific data elements are required to complete said at least one form; and
rendering said at least form using said specific data elements.

18. A computer-readable medium encoded with a computer program for qualification, enrollment, and rendering, said computer program being configured to:
use at least one weighting factor to determine eligibility for a plurality of potential outcomes by presenting a dynamic qualification interview to at least one candidate;
identify at least one acceptable outcome from said plurality of potential outcomes, based on said dynamic qualification interview;
acquire a plurality of data elements from said at least one candidate, said plurality of data elements being necessary for participation in said at least one acceptable outcome;
use said plurality of data elements to render at least one form required for candidate participation is said at least one successful outcome; and
display or transmit said at least one form to or on at least one of a computer screen, a page printed by a printer, or a page printed by a fax machine.

19. The computer-readable medium of claim 18 wherein said at least one weighting factor comprises at least one of a statistical weighting factor and a geographic weighting factor, said geographic weighting factor being derived by identifying a geographic location for said at least one candidate and a geographic location for each of said plurality of benefits programs, said statistical weighting factor being derived from a historical acceptance rate for each of said plurality of benefits programs.

20. The computer-readable medium of claim 18 wherein said computer program is further configured to automatically enroll said at least one candidate in at least one benefits program associated with said at least one acceptable outcome using at least some information gathered from said at least one candidate during said dynamic qualification interview.

21. The computer-readable medium of claim 18 wherein said computer-readable medium comprises at least one of recordable media and transmission media.
